(19) United States
(12) Patent Application Publication
(10) Pub. No.: US 2025/0370374 A1
(43) Pub. Date: Dec. 4, 2025

(54) DEVELOPING DEVICE, PROCESS CARTRIDGE, AND IMAGE FORMING APPARATUS

(71) Applicants: Hotaru HASHIKAWA, Kanagawa (JP); Kei SAITO, Tokyo (JP); Yuuki TSUCHIYA, Kanagawa (JP)

(72) Inventors: Hotaru HASHIKAWA, Kanagawa (JP); Kei SAITO, Tokyo (JP); Yuuki TSUCHIYA, Kanagawa (JP)

(21) Appl. No.: 19/200,697

(22) Filed: May 7, 2025

(30) Foreign Application Priority Data
May 29, 2024 (JP) 2024-087010

(51) Int. Cl. G03G 15/08; G03G 21/16; G03G 21/18

(52) U.S. Cl. CPC G03G 15/0808; G03G 15/0891; G03G 21/1676; G03G 21/1814; G03G 2215/088; G03G 2221/163

(57) ABSTRACT

A developing device includes a developing roller, a developer supply rotator, a removable sheet-shaped member, an upper developing case, and a lower developing case. The developer supply rotator is opposite the developing roller to supply developer to the developing roller. The removable sheet-shaped member separates the developing roller and the developer supply rotator to form a developer pre-storage portion storing the developer in an inner space in which the developer supply rotator is disposed in the developing device. The upper developing case is above the sheet-shaped member to cover the developing roller. The lower developing case is below the sheet-shaped member to form a developing case together with the upper developing case and is divided into a first lower developing case and a second lower developing case. The sheet-shaped member is removably attached directly or indirectly to the first lower developing case and the second lower developing case.

### CROSS-REFERENCE TO RELATED APPLICATION

This patent application is based on and claims priority pursuant to 35 U.S.C. § 119 (a) to Japanese Patent Application No. 2024-087010, filed on May 29, 2024, in the Japan Patent Office, the entire disclosure of which is hereby incorporated by reference herein.

### BACKGROUND

### Technical Field

The present disclosure relates to a developing device that develops a latent image formed on an image bearer such as a photoconductor drum, a process cartridge including the developing device, and an image forming apparatus including the developing device.

### Related Art

In a developing device removably installed in an image forming apparatus such as a copier or a printer, a technique has been proposed in which a sheet-shaped member (sealing member) is removably installed to isolate, as a closed space, a space in which developer is stored so that the developer stored inside the developing device does not leak outside the developing device during transportation after the shipment from a factory.

### SUMMARY

The present disclosure described herein provides a developing device detachably attachable to a body of an image forming apparatus and storing developer that includes a developing roller, a developer supply rotator, a removable sheet-shaped member, an upper developing case, and a lower developing case. The developing roller develops a latent image formed on a surface of an image bearer. The developer supply rotator is opposite the developing roller to rotate in a specified direction to supply the developer to the developing roller. The removable sheet-shaped member separates the developing roller and the developer supply rotator to form a developer pre-storage portion storing the developer in an inner space in which the developer supply rotator is disposed in the developing device. The upper developing case is above the sheet-shaped member to cover the developing roller. The lower developing case is below the sheet-shaped member to form a developing case together with the upper developing case and is divided into a first lower developing case and a second lower developing case when viewed in a cross section orthogonal to a rotation axis direction of the developing roller. The sheet-shaped member is removably attached directly or indirectly to the first lower developing case and the second lower developing case to straddle the first lower developing case and the second lower developing case.

The present disclosure described herein also provides a process cartridge detachably attachable to the body of the image forming apparatus that includes the developing device and the image bearer united with the developing device.

The present disclosure described herein further provides an image forming apparatus that includes the developing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a cross-sectional view of an image forming device of the image forming apparatus of FIG. 1;

FIG. 3 is a cross-sectional view of a developing device of the image forming device of FIG. 2 as viewed along a longitudinal direction;

FIG. 4 is an enlarged view of the developing device of FIG. 3;

FIG. 5 is a top view of a base portion of an upper developing case in a longitudinal direction;

FIG. 6 is an enlarged view of a joint between a first lower developing case and a second lower developing case, and a vicinity of the joint;

FIG. 7 is an enlarged view of a developing device according to a comparative example; and

FIG. 8 is a diagram illustrating a positional relation between a gear train and a sheet-shaped member in a developing device according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Like reference signs are assigned to like elements or components and descriptions of those elements or components may be simplified or omitted. As used herein, the singular forms “a,” “an,” and “the” are intended to include the plural forms as well, unless the context clearly indicates otherwise.

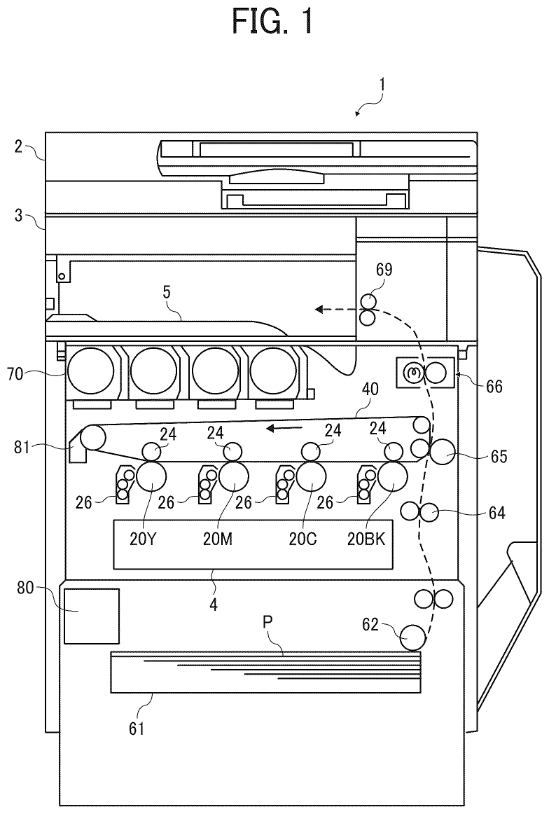

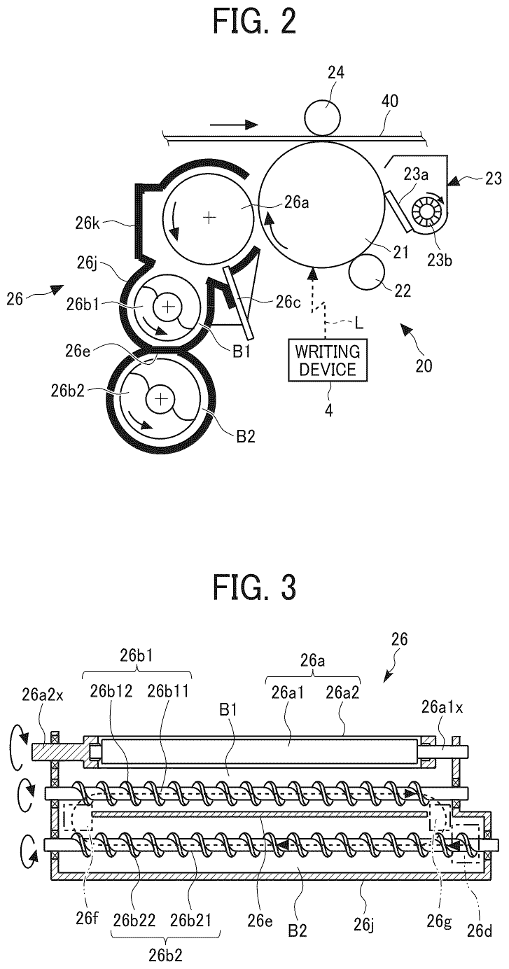

First, with reference to FIG. 1, a description is given of an overall configuration and an operation of an image forming apparatus 1 according to an embodiment of the present disclosure. The image forming apparatus 1 according to the present embodiment is a tandem-type multicolor image forming apparatus in which process cartridges 20Y, 20M, 20C, and 20BK are arranged in parallel to each other, facing an intermediate transfer belt 40. In each of the process cartridges 20Y, 20M, 20C, and 20BK, a developing device 26 (see FIG. 2) is disposed to face a photoconductor drum 21 serving as an image bearer.

In FIG. 1, a body of the image forming apparatus 1, which is illustrated as a color copier in the present embodiment, includes a document conveying device 2, a scanner 3 (document reading device), and a writing device 4 (exposure device). The document conveying device 2 conveys documents to the scanner 3. The scanner 3 scans the documents to read image data. The writing device 4 emits a laser beam based on input image data. Yellow, magenta, cyan, and black toner images are formed on the surfaces of the photoconductor drums 21 of the process cartridges 20Y, 20M, 20C, and 20BK, respectively. The yellow, magenta, cyan, and black toner images on the photoconductor drums 21 are transferred onto the intermediate transfer belt 40 and superimposed. The image forming apparatus 1 further includes a sheet feeder 61, a secondary transfer roller 65, and a fixing device 66. The sheet feeder 61 stores sheets P such as paper sheets. The secondary transfer roller 65 transfers the toner images formed on the intermediate transfer belt 40 onto a sheet P. The fixing device 66 fixes an unfixed toner image on the sheet P. The image forming apparatus 1 still further includes toner containers 70, cleaning devices 23, an intermediate-transfer-belt cleaner 81, and a waste-toner container 80. The toner containers 70 supply toner of the four colors to the respective developing devices 26 of the process cartridges 20Y, 20M, 20C, and 20BK. The waste-toner container 80 collects, as waste toner, untransferred toner collected by the cleaning devices 23 (see FIG. 2) and the intermediate-transfer-belt cleaner 81. Each of the process cartridges 20Y, 20M, 20C, and 20BK includes the photoconductor drum 21 serving as an image bearer, a charging device 22, and a cleaning device 23, which are united as a single unit as illustrated in FIG. 2. Each of the process cartridges 20Y, 20M, 20C, and 20BK, which is expendable, is removed from a body of the image forming apparatus 1 and replaced with a new one when depleted in the body of the image forming apparatus 1. The developing device 26 is disposed to face the photoconductor drum 21 in each of the process cartridges 20Y, 20M, 20C, and 20BK. Each of the developing devices 26, which is expendable, is removed from the body of the image forming apparatus 1 and replaced with a new one when depleted in the body of the image forming apparatus 1. The attachment and detachment operations of the developing device 26 with respect to the body of the image forming apparatus 1 and the attachment and detachment operations of the process cartridges 20Y, 20M, 20C, and 20BK with respect to the body of the image forming apparatus 1 can be independently performed as different operations. In the process cartridges 20Y, 20M, 20C, and 20BK, the yellow, magenta, cyan, and black toner images are formed, respectively, on the respective photoconductor drums 21 as the image bearers.

A description is given below of operations of the image forming apparatus 1 to form a normal color toner image. A conveying roller of the document conveying device 2 conveys a document from a document table onto an exposure glass of the scanner 3. The scanner 3 optically scans image data for the document on the exposure glass. The yellow, magenta, cyan, and black image data are transmitted to the writing device 4. The writing device 4 irradiates the surface of the photoconductor drums 21 (see FIG. 2) of the process cartridges 20Y, 20M, 20C, and 20BK with laser beams (as exposure light) L according to the yellow, magenta, cyan, and black image data, respectively.

Meanwhile, the four photoconductor drums 21 rotate clockwise as illustrated in FIGS. 1 and 2. The surface of the photoconductor drum 21 is uniformly charged at the position opposite the charging device 22 (a charging roller) (charging process). Thus, the surface of the photoconductor drum 21 is charged to a charging potential. When the charged surface of the photoconductor drum 21 reaches the position to receive the laser beam L emitted from the writing device 4, an electrostatic latent image is formed at the position on the surface of the photoconductor drum 21 according to the image data (exposure process).

The laser beam L corresponding to the yellow image data is emitted to the surface of the photoconductor drum 21 in the process cartridge 20Y, which is the first from the left in FIG. 1 among the four process cartridges 20Y, 20M, 20C, and 20BK. A polygon mirror that rotates at high velocity directs the laser beam L for the yellow image data to the surface of the photoconductor drum 21 along a rotation axis direction of the photoconductor drum 21 (i.e., the main scanning direction). Thus, an electrostatic latent image corresponding to the yellow image data is formed on the photoconductor drum 21 charged by the charging device 22. Similarly, the laser beam L corresponding to the cyan image data is emitted to the surface of the photoconductor drum 21 in the second process cartridge 20C from the left in FIG. 1, thus forming an electrostatic latent image corresponding to the cyan image data on the surface of the photoconductor drum 21. The laser beam L corresponding to the magenta image data is emitted to the surface of the photoconductor drum 21 in the third process cartridge 20M from the left in FIG. 1, thus forming an electrostatic latent image corresponding to the magenta image data on the surface of the photoconductor drum 21. The laser beam L corresponding to the black image data is emitted to the surface of the photoconductor drum 21 in the fourth process cartridge 20BK from the left in FIG. 1, thus forming an electrostatic latent image corresponding to the black image data on the surface of the photoconductor drum 21.

Then, the surface of the photoconductor drum 21 bearing the electrostatic latent image for each color reaches the position opposite the developing device 26. The developing device 26 supplies toner onto the surface of the photoconductor drum 21 and develops the electrostatic latent image on the photoconductor drum 21 into a toner image (development process). After the development process, the surface of the photoconductor drum 21 reaches the position opposite the intermediate transfer belt 40. Primary transfer rollers 24 are disposed at the positions where the surfaces of the corresponding photoconductor drums 21 face the intermediate transfer belt 40 such that the primary transfer rollers 24 contact an inner circumferential surface of the intermediate transfer belt 40. At the positions of the primary transfer rollers 24, the toner images on the photoconductor drums 21 are sequentially transferred to and superimposed on the intermediate transfer belt 40, forming a multicolor toner image thereon (primary transfer process).

After the primary transfer process, the surface of the photoconductor drum 21 reaches a position opposite the cleaning device 23. The cleaning device 23 collects untransferred toner remaining on the photoconductor drum 21 (cleaning process). The untransferred toner collected in the cleaning device 23 passes through a waste-toner conveyance passage and is collected as waste toner in the waste-toner container 80. Then, a charge elimination device discharges a residual potential of the surface of the photoconductor drum 21 at the position opposite the charge elimination device. Thus, a series of image forming processes performed on the photoconductor drum 21 is completed.

Meanwhile, the surface of the intermediate transfer belt 40, onto which the single-color toner images on the photoconductor drums 21 are transferred and superimposed, moves in a direction indicated by an arrow in FIG. 1 and reaches a position opposite a secondary transfer roller 65. The secondary transfer roller 65 secondarily transfers the multicolor toner image on the intermediate transfer belt 40 onto the sheet P (secondary transfer process). After the secondary transfer process, the surface of the intermediate transfer belt 40 reaches the position opposite an intermediate-transfer-belt cleaner 81. The intermediate-transfer-belt cleaner 81 collects the untransferred toner on the intermediate transfer belt 40 to complete a series of transfer processes on the intermediate transfer belt 40. The untransferred toner collected in the intermediate-transfer-belt cleaner 81 passes through a waste-toner conveyance passage and is collected as waste toner in the waste-toner container 80.

The sheet P is conveyed from the sheet feeder 61 to the position of the secondary transfer roller 65 via, for example, a registration roller pair 64. Specifically, a feed roller 62 feeds the sheet P from the top of multiple sheets P stored in the sheet feeder 61. The sheet P is conveyed to the registration roller pair 64 through a sheet conveyance passage. The sheet P that has reached the registration roller pair 64 is conveyed toward the position of the secondary transfer roller 65 so that the sheet P timely meets the arrival of the multicolor toner image on the intermediate transfer belt 40.

Subsequently, the sheet P, onto which the multicolor image is transferred, is conveyed to a fixing device 66. The fixing device 66 includes a fixing roller and a pressure roller pressing against each other. In a nip between the fixing roller and the pressure roller, the multicolor toner image is fixed on the sheet P. After the fixing process, an output roller pair 69 ejects the sheet P as an output image outside the body of the image forming apparatus 1. The ejected sheets P are stacked on an output tray 5. Thus, a series of image forming processes (printing) is completed.

With reference to FIGS. 2 and 3, a description is given in detail below of image forming devices of the image forming apparatus. The four image forming devices disposed in the body of the image forming apparatus 1 (see FIG. 1) have a similar configuration except the colors of the toner used in the image forming processes. Thus, components of the image forming device such as the process cartridge and the developing device are illustrated without suffixes Y, M, C, and BK, which denote the colors of the toner, in the drawings.

As illustrated in FIG. 2, the process cartridge 20 includes the photoconductor drum 21 as the image bearer, the charging device 22, and the cleaning device 23, which are stored in a case of the process cartridge 20 as a single unit. The photoconductor drum 21 is an organic photoconductor designed to be charged with a negative polarity and includes a photosensitive layer formed on a drum-shaped conductive support. The charging device 22 is a charging roller including a conductive core and an elastic layer of moderate resistivity overlaid on the outer circumference of the conductive core. A power supply applies a specified voltage to the charging device 22 (charging roller). Thus, the charging device 22 uniformly charges the surface of the photoconductor drum 21 facing the charging device 22. The cleaning device 23 includes a cleaning blade 23a and a cleaning roller 23b that contact the photoconductor drum 21. For example, the cleaning blade 23a is made of rubber, such as urethane rubber, and contacts the surface of the photoconductor drum 21 at a specified angle with a specified pressure. The cleaning roller 23b is a brush roller in which brush bristles are provided around a core.

As illustrated in FIGS. 2 and 3, the developing device 26 includes a developing roller 26a as a developer bearer, a first conveying screw 26b1 (conveying screw) as a developer supply rotator facing the developing roller 26a, a partition 26e, a second conveying screw 26b2 opposing a lower portion of the first conveying screw 26b1 via the partition 26e, and a doctor blade 26c as a developer regulator facing the developing roller 26a below to regulate the amount of developer borne on a surface of the developing roller 26a.

The developing device 26 stores developer (two-component developer containing additives) including carrier and toner. In the present embodiment, the average particle diameter of the toner is set to about 5.2 μm, the average particle diameter of the carriers is set to about 35 μm, and the toner concentration is set to about 7 wt %.

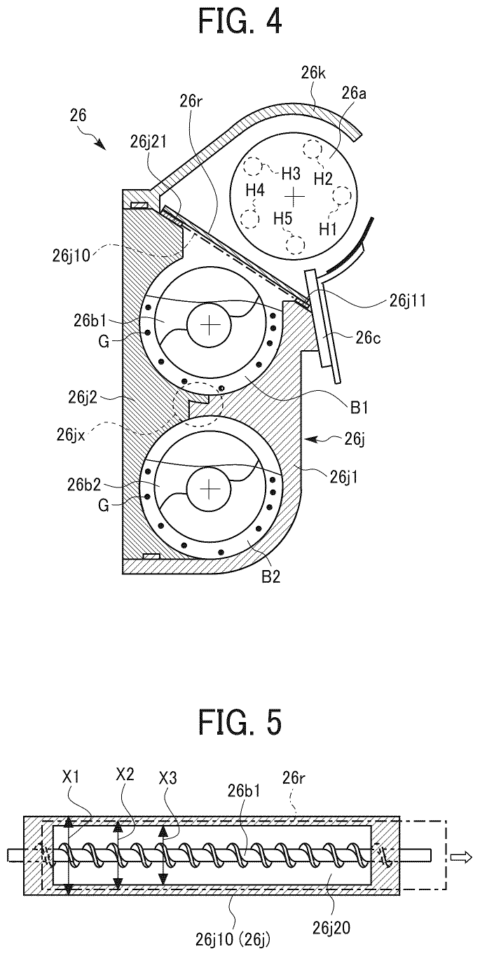

The developing roller 26a faces the photoconductor drum 21 with a small gap (development gap), thereby forming a developing area. As illustrated in FIG. 3, the developing roller 26a includes a magnet 26a1 fixed inside with non-rotatably manner and a sleeve 26a2 that rotates around the magnet 26a1. The magnet 26a1 generates multiple magnetic poles H1 to H5 (see FIG. 4) around an outer circumferential surface of the developing roller 26a. The magnet 26a1 generates a plurality of magnetic poles H1 to H5 on the outer circumferential surface of the developing roller 26a.

Specifically, with reference to FIG. 4, a scooping magnetic pole H5 (that is located at a position facing the doctor blade 26c or a position adjacent to above-described position) acts on the carrier as magnetic materials, and developer G contained in a first conveyance passage B1 (see FIG. 2) is scooped up onto the developing roller 26a. A part of the developer G borne on the developing roller 26a is scraped off at the position of the doctor blade 26c (see FIG. 2) and returned to the first conveyance passage B1. On the other hand, the developer G that has passed through a doctor gap between the doctor blade 26c and the developing roller 26a at the position of the doctor blade 26c where the magnetic force by the scooping magnetic pole H5 acts and has been borne on the developing roller 26a stands at the position of a main magnetic pole H1 of the multiple magnetic poles, forms a magnetic brush in the developing area, and slidingly contacts the photoconductor drum 21. Thus, the toner in the developer G borne on the developing roller 26a adheres to the latent image formed on the photoconductor drum 21. Thereafter, the developer G that has passed through the position of the main magnetic pole H1 is conveyed by a plurality of conveying magnetic poles H2 and H3 between the main magnetic pole H1 and an upper developing case 26k, and then is conveyed to the position of the developer releasing magnetic pole H4. A repulsive magnetic field (the magnetic field that acts in a direction away from the developing roller 26a) acts on the carrier at the position of the developer releasing magnetic pole H4, and the developer G borne on the developing roller 26a after the development process is removed from the developing roller 26a. The removed developer G drops into the first conveyance passage B1 and is conveyed downstream from the first conveyance passage B1 by the first conveying screw 26b1 (see FIGS. 2 and 3).

The first conveying screw 26b1 and the second conveying screw 26b2 convey the developer stored in the developing device 26 in a longitudinal direction (in a rotation axis direction) of the developing device 26, thereby establishing a circulation passage indicated by the dashed arrow in FIG. 3. In other words, the circulation path of the developer includes the first conveyance passage B1 including the first conveying screw 26b1 and the second conveyance passage B2 including the second conveying screw 26b2. The partition 26e is a wall and separates the first conveyance passage B1 from the second conveyance passage B2. The first conveyance passage B1 and the second conveyance passage B2 communicate with each other via a first communication opening 26f and a second communication opening 26g disposed at both longitudinal ends of the first conveyance passage B1 and the second conveyance passage B2. Specifically, with reference to FIG. 3, in a conveyance direction of the developer, an upstream end of the first conveyance passage B1 communicates with a downstream end of the second conveyance passage B2 via the first communication opening 26f. On the other hand, in the conveyance direction of the developer, a downstream end of the first conveyance passage B1 communicates with an upstream end of the second conveyance passage B2 via the second communication opening 26g. In other words, the partition 26e is disposed along the circulation passage except both longitudinal ends of the circulation passage.

The first conveying screw 26b1 (or the first conveyance passage B1) is disposed to face the developing roller 26a obliquely downward. The second conveying screw 26b2 (or the second conveyance passage B2) is disposed to oppose the lower portion of the first conveying screw 26b1 (or the first conveyance passage B1) via the partition 26e (wall). The first conveying screw 26b1 supplies developer toward the developing roller 26a and collects the developer separated from the developing roller 26a after the development process while conveying the developer in the rotation axis direction (in the longitudinal direction) of the developing device 26. The second conveying screw 26b2 stirs and mixes the developer after the development process conveyed from the first conveyance passage B1 with fresh toner supplied from a toner supply inlet 26d (see FIG. 3) while conveying the developer and the fresh toner in the longitudinal direction of the developing device 26. In the present embodiment, the two conveying screws (i.e., the first conveying screw 26b1 and the second conveying screw 26b2) are vertically arranged in parallel. The two conveying screws (i.e., the first conveying screw 26b1 and the second conveying screw 26b2) includes rotation shafts (i.e., a rotation shaft 26b11 and a rotation shaft 26b21) and screw portions (i.e., a screw portion 26b12 and a screw portion 26b22) wound around the rotation shafts, respectively. As described above, the circulation path of the developer G (the first conveyance passage B1 and the second conveyance passage B2) with respect to the developing roller 26a is not horizontally but vertically formed, so that the size of the developing device 26 can be reduced in the horizontal direction (the size of the developing device 26 can be extended in the vertical direction). In particular, in the tandem-color image forming apparatus 1 in which the plurality of developing devices 26 (image forming devices) are arranged in the horizontal direction, reducing the horizontal sizes of the plurality of developing devices 26 (image forming devices) can effectively reduce the entire size of the image forming apparatus 1 in the horizontal direction.

With reference to FIG. 2, in the present embodiment, the developing device 26 includes an upper developing case 26k and a lower developing case 26j as developing cases (housings) of the developing device 26. The lower developing case 26j rotatably holds the first conveying screw 26b1 and the second conveying screw 26b2, and holds the doctor blade 26c. The lower developing case 26j rotatably holds the sleeve 26a2 (a rotation shaft 26a2x) of the developing roller 26a, and non-rotatably holds the magnet 26a1 (a non-rotation shaft 26a1x) of the developing roller 26a. On the other hand, the upper developing case 26k is disposed above the lower developing case 26j to cover the lower developing case 26j (developing roller 26a). The upper developing case 26k is detachably attached to the lower developing case 26j holding the developing roller 26a, the first conveying screw 26b1, the second conveying screw 26b2, and the doctor blade 26c by snap-on clips or screws. The lower developing case 26j is dividable into a first lower developing case 26j1 and a second lower developing case 26j2, which is described in detail later.

A description is further given below of the image forming processes described above, focusing on the development process. The developing roller 26a rotates in a specified direction that is counterclockwise indicated by an arrow in FIG. 2. As illustrated in FIGS. 2 and 3, the first conveying screw 26b1 and the second conveying screw 26b2 are disposed with the partition 26e interposed therebetween and rotate in respective directions indicated by arrows in FIGS. 2 and 3. Toner is supplied from the toner container 70 to a toner supply inlet 26d through a toner supply passage. As the first conveying screw 26b1 and the second conveying screw 26b2 rotate in the respective directions in FIG. 2, the developer stored in the developing device 26 circulates together with the supplied toner in the longitudinal direction of the developing device 26 (the direction indicated by the dashed arrow in FIG. 3) while being stirred and mixed with the supplied toner. The toner is charged by friction with carrier in the developer and electrostatically attracted to the carrier. Then, the toner is scooped up on the developing roller 26a together with the carrier by a developer scooping pole H5 generated on the developing roller 26a. The developer borne on the developing roller 26a is conveyed in the counterclockwise direction indicated by the arrow in FIG. 2 to the position opposite the doctor blade 26c. The doctor blade 26c adjusts the amount of the developer on the developing roller 26a to a proper amount at this position. Subsequently, the rotation of the sleeve 26a2 of the developing roller 26a conveys the developer to the developing area in which the developing roller 26a faces the photoconductor drum 21. Then, the toner in the developer G is attracted to the electrostatic latent image formed on the photoconductor drum 21 due to the effect of an electric field generated in the developing area. As the sleeve 26a2 rotates, the developer remaining on the developing roller 26a reaches above the first conveyance passage B1 and is separated from the developing roller 26a. The electric field in the developing area is generated by a specified voltage (in other words, a development bias) applied to the developing roller 26a by a development power supply and a surface potential (in other words, a latent image potential) formed on the surface of the photoconductor drum 21 in the charging process and the exposure process.

The toner in the toner container 70 is supplied as appropriate through a toner supply passage to the developing device 26 via the toner supply inlet 26d (see FIG. 3) as the toner in the developing device 26 is consumed. The toner consumption in the developing device 26 is detected by a toner concentration sensor that magnetically detects a toner concentration in the developer (i.e., a ratio of toner to the developer) in the developing device 26. The toner supply inlet 26d is disposed above an end of the second conveying screw 26b2 (or the second conveyance passage B2) in a longitudinal direction (left-and-right direction in FIG. 3) of the second conveying screw 26b2.

A detailed description is given below of the configuration and operation of the developing device 26 (image forming apparatus 1) according to the present embodiment. The developing device 26 in the present embodiment is installed to be attachable to and detachable from (i.e. replaceable in) the body of the image forming apparatus 1 and is replaced with a new one (including a recycled one) in a specified replacement cycle. As described above with reference to FIG. 2, in the developing device 26, the developing roller 26a, the first conveying screw 26b1 as a developer supply rotator, and the second conveying screw 26b2, are disposed in the developing case (including the upper developing case 26k and the lower developing case 26j). In the developing device 26, the doctor blade 26c serving as a developer regulator is disposed on the lower developing case 26j to face the developing roller 26a disposed obliquely above the first conveying screw 26b1 (developer supply rotator) from below and regulates the amount of the developer G borne on the surface of the developing roller 26a.

With reference to FIG. 4, the developing device 26 of the present embodiment includes a sheet-shaped member 26r (which is detachably attached to the developing device 26) to separate the developing roller 26a and the first conveying screw 26b1 (developer supply rotator) to two portions to form a developer pre-storage portion (substantially closed space) in which the developer G is stored inside the part including the first conveying screw 26b1 (the first conveyance passage B1 and the second conveyance passage B2) of the developing device 26 so that the developer G stored in the developing device 26 (the developer G packed in advance at the time of shipment from a factory) does not leak to the outside of developing device 26 until the use of the developer G in the body of the image forming apparatus 1 is started.

Specifically, the sheet-shaped member 26r is a flexible member that is made of a transparent plastic material such as an overhead projector (OHP) transparency sheet or a MYLAR sheet having a thickness of approximately 0.1 to 0.5 mm. The flexible sheet-shaped member 26r has a substantially rectangular shape to extend in the rotation axis direction (the rotation axis direction of the developing roller 26a, the first conveying screw 26b1, and the second conveying screw 26b2, that is, the left-and-right direction in FIG. 5). The sheet-shaped member 26r is adhered (bonded) to a base portion 26j10 by a double-sided tape or thermal fusion bonding, to cover an opening 26j20 (see FIG. 5) formed in the base portion 26j10 (in the present disclosure, which is disposed and fixed as a separate component) disposed in the lower developing case 26j in order to communicate the space in which the developing roller 26a is disposed and the space in which the first conveying screw 26b1 is disposed (the first conveyance passage B1). A new developing device 26 (including a recycled product) is shipped from a factory in a state in which the sheet-shaped member 26r is disposed as illustrated in FIG. 4. In other words, after the developer G is filled into the inside (the first conveyance passage B1 and the second conveyance passage B2) of the developing device 26 in a state where the assembly of the sheet-shaped member 26r to the lower developing case 26j is completed, the sheet-shaped member 26r is adhered to the base portion 26j10 to seal the first conveyance passage B1 and the second conveyance passage B2 so that the developer G does not leak to the outside of the developing device 26. Finally, the upper developing case 26k is installed to cover the lower developing case 26j in a state where the sheet-shaped member 26r is set. The developing device 26, in which the developer G is preset, for shipment is completed. In the present embodiment, the assembling procedure is such that, in the factory, after the developer G is filled into the developing device 26 in a state in which the assembling to the lower developing case 26j is completed, the sheet-shaped member 26r is adhered to the base portion 26j10 of the lower developing case 26j, and thereafter, the upper developing case 26k is installed, but the assembling procedure is not limited thereto. For example, the sheet-shaped member 26r may be adhered to the base portion 26j10 of the lower developing case 26j with respect to the developing device 26 in a state in which the assembling to the lower developing case 26j is completed, and then the upper developing case 26k may be installed, and finally, the developer G may be filled into the developing device 26 after the assembling is completed.

With reference to FIG. 5, one end (a part) of the sheet-shaped member 26r set in the developing device 26 in the longitudinal direction (the direction perpendicular to the plane on which FIG. 4 is illustrated and the left-and-right direction in FIG. 5) protrudes to the outside of the developing device 26 from a clearance between the upper developing case 26k and the lower developing case 26j. A user grips the protruding portion and pulls out the protruding portion in the direction indicated by the white arrow in FIG. 5, so that the opening 26j20 of the base portion 26j10 is opened, and the developing device 26 is ready for use.

As illustrated in FIG. 4, the developing device 26 having such a configuration is attached to the body of the image forming apparatus 1 in a state in which the developer G contained inside the developing device 26 is enclosed and sealed by the sheet-shaped member 26r. Such cases are as follows: (a) the case where the body of the image forming apparatus 1 as a new one in which the developing device 26 as a new one is installed is shipped, and (b) the case where the developing device 26 as a new one for replacement is installed in the body of the image forming apparatus 1 already being used by a user. In any of the above-described cases, before the use (development process) of the developing device 26 as a new one in the body of the image forming apparatus 1 is started, the sheet-shaped member 26r in the enclosed and sealed state is pulled out from the developing device 26. Then, a normal image forming process (development process) is performed in the state as illustrated in FIG. 2.

As described above, in the present embodiment, even when the developing device 26 alone is transported (carried) as a replacement device or when the developing device 26 is transported in a state of being attached to the body of the image forming apparatus 1 at the time of shipment, the developer G stored in the developing device 26 in advance is sealed by the sheet-shaped member 26r. As a result, a disadvantage that the developer G stored in the developing device 26 leaks to the outside of the developing device 26 due to, for example, vibration generated during transportation can be prevented.

In particular, in the present embodiment, as illustrated in FIG. 4, the sheet-shaped member 26r is disposed to separate the developing roller 26a and the first conveying screw 26b1 in the developing device 26 to form a closed space. With such a configuration, the developer G is not borne on the developing roller 26a during transportation. Thus, a disadvantage that a user touches the surface of the developing roller 26a and hands of the user are got dirty with the developer G can be reliably prevented. Even when the developing device 26 as a new one is installed in the body of the image forming apparatus 1 as a new one to ship the image forming apparatus 1 from a factory, a disadvantage that the surface of the photoconductor drum is damaged by the developer G borne on the surface of the developing roller 26a during transportation can be prevented.

As illustrated in FIG. 4, in the present embodiment, the doctor blade 26c (developer regulator) is disposed obliquely above the developing roller 26a with respect to the first conveying screw 26b1 to face the developing roller 26a from below. The base portion 26j10 is formed such that a downstream sheet sticking position 26j11 is located at a position lower than a top Z of the first conveying screw 26b1 (developer supply rotator), and an upstream sheet sticking position 26j21 is located at a position higher than the top Z. With such a configuration, the sheet-shaped member 26r can be easily disposed to be orthogonal to a virtual line connecting the rotation center of the developing roller 26a and the rotation center of the first conveying screw 26b1. The sheet-shaped member 26r is disposed in such a manner that the space between the developing roller 26a and the first conveying screw 26b1 is efficiently separated. Thus, the facing distance between the developing roller 26a and the first conveying screw 26b1 is set to be short so that the developing device 26 can be reduced in size and weight, and the amount of the developer G for preset can be reduced.

As illustrated in FIG. 4, in the present embodiment, the doctor blade 26c (developer regulator) is set such that the position of the tip (upper end) facing the developing roller 26a is higher than the downstream sheet sticking position 26j11 and lower than the upstream sheet sticking position 26j21. With such a configuration, the sheet-shaped member 26r can be easily disposed to be orthogonal to a virtual line connecting the rotation center of the developing roller 26a and the rotation center of the first conveying screw 26b1 while the function of the doctor blade 26c is preferably maintained.

As illustrated in FIG. 5, in the developing device 26 according to the present embodiment, a range X2 of the sheet-shaped member 26r in the lateral direction is set to be within a range X1 of the base portion 26j10 in the lateral direction and to include a range X3 of the opening 26j20 in the lateral direction. In other words, when the width of the outer peripheral portion of the base portion 26j10 in the lateral direction is X1, the width of the opening 26j20 in the lateral direction is X3, and the width of the sheet-shaped member 26r in the lateral direction is X2, the relation of X1>X2>X3 is established. With such a configuration, the opening 26j20 is reliably sealed by the sheet-shaped member 26r. Twisting and getting caught are unlikely to occur in the sheet-shaped member 26r at the start of use of the developing device 26 so that the sheet-shaped member 26r can be easily pulled out in the direction indicated by the white arrow in FIG. 5.

As described above with reference to FIG. 4, the developing device 26 in the present embodiment includes the upper developing case 26k and the lower developing case 26j. The upper developing case 26k is disposed substantially above the sheet-shaped member 26r to cover the developing roller 26a. On the other hand, the lower developing case 26j is disposed substantially below the sheet-shaped member 26r, and forms a developing case together with the upper developing case 26k.

As illustrated in FIG. 4, in this embodiment, the lower developing case 26j is divided into two portions, that is, the first lower developing case 26j1 and the second lower developing case 26j2, when viewed in a cross section orthogonal to the rotation axis direction of the developing roller 26a. In other words, the developing case is divided into three portions, that is, the upper developing case 26k, the first lower developing case 26j1, and the second lower developing case 26j2. In the lower developing case 26j, the sheet-shaped member 26r is directly or indirectly removably installed to straddle the first lower developing case 26j1 and the second lower developing case 26j2.

Specifically, in the present embodiment, the sheet-shaped member 26r is indirectly detachably attached via the base portion 26j10 (base member) to straddle the first lower developing case 26j1 and the second lower developing case 26j2. The base portion 26j10 is adhered (bonded) as a separate component to the lower developing case 26j via a double-sided tape or an adhesive. As described above, in the present embodiment, the sheet-shaped member 26r is not directly adhered (bonded) to the divided cases (the first lower developing case 26j1 and the second lower developing case 26j2) to straddle the divided cases, but the sheet-shaped member 26r is indirectly adhered (bonded) to the divided cases (the first lower developing case 26j1 and the second lower developing case 26j2) via the base portion 26j10 to straddle the divided cases. Accordingly, the flexibility of material selection of the base portion 26j10 is enhanced (a material compatible with the sheet-shaped member 26r can be selected), and the stickiness (adhesiveness) of the sheet-shaped member 26r can be enhanced. Even if there is a step or a clearance at a joint between the first lower developing case 26j1 and the second lower developing case 26j2, the sealing property by the sheet-shaped member 26r can be obtained. In the present embodiment, the base portion 26j10 is disposed as a separate component on the lower developing case 26j. However, in the case where the above-described disadvantages (such as the material, the step, and the clearance) can be solved, the sheet-shaped member 26r may be directly adhered (bonded) to the lower developing case 26j.

More specifically, in the present embodiment, as illustrated in FIG. 4, the lower developing case 26j is divided into the first lower developing case 26j1 disposed on a side corresponding to the downstream side of the developing roller 26a in the rotation direction (right side in FIG. 4) and the second lower developing case 26j2 disposed on a side corresponding to the upstream side of the developing roller 26a in the rotation direction (left side in FIG. 4) at a substantially central position of the lower developing case 26j when viewed in a cross section orthogonal to the rotation axis direction of the developing roller 26a.

In particular, the developing roller 26a, the first conveying screw 26b1, the second conveying screw 26b2, and the doctor blade 26c are disposed in the first lower developing case 26j1. In the assembling process of the lower developing case 26j, the second lower developing case 26j2 is detachably attached to the first lower developing case 26j1, on which the first conveying screw 26b1, the second conveying screw 26b2, and the doctor blade 26c are disposed, from the lateral direction of FIG. 4 by snap-on clip or screw fastening. Accordingly, in the lower developing case 26j, the operation of assembling the developing roller 26a, the first conveying screw 26b1, the second conveying screw 26b2, and the doctor blade 26c is also facilitated. The preset developer G is stored in the developer pre-storage portion (the first conveyance passage B1 and the second conveyance passage B2) of the lower developing case 26j assembled in this manner, and thus, the base portion 26j10 to which the sheet-shaped member 26r is adhered is installed. Finally, the upper developing case 26k is installed on the lower developing case 26j in such a state, and the developing device 26 in a shipping state is completed. As described above, the assembling procedure of the developing device 26 at the time of shipment is not limited to this, and the developer G may be finally filled into the developing device 26 in a state in which the assembly of, for example, the developing roller 26a, the first conveying screw 26b1, the second conveying screw 26b2, the doctor blade 26c, the sheet-shaped member 26r, and the upper developing case 26k, to the lower developing case 26j is completed.

As described above, in the developing device 26 according to the present embodiment, the sheet-shaped member 26r is easily disposed to separate the developing roller 26a and the first conveying screw 26b1 (developer supply rotator) in the assembly process of the developing device 26, as compared to a developing device 126 illustrated as a comparative example in FIG. 7 that is divided into two parts of a first developing case 126k and a second developing case 126j. Specifically, the developing device 126 illustrated as a comparative example in FIG. 7 is formed such that the first developing case 126k formed to cover the first conveyance passage B1 and the second conveyance passage B2 from above the developing roller 26a to the side (rear side) of the first conveyance passage B1 and the second conveyance passage B2 is combined with the second developing case 126j (in which the developing roller 26a, the first conveying screw 26b1, the second conveying screw 26b2, and the doctor blade 26c are installed) formed to cover the side (front side) of the first conveyance passage B1 and the second conveyance passage B2. Accordingly, the sheet-shaped member 26r (base portion 26j10) is preferably installed to be slidingly inserted between the developing roller 26a and the first conveying screw 26b1, and thus the installation operation becomes difficult. On the other hand, in the present embodiment, as described above, the operation of storing the developer G in the developer pre-storage portion of the lower developing case 26j and the subsequent operation of sealing the developer pre-storage portion by installing the sheet-shaped member 26r (base portion 26j10) to the lower developing case 26j can be smoothly performed.

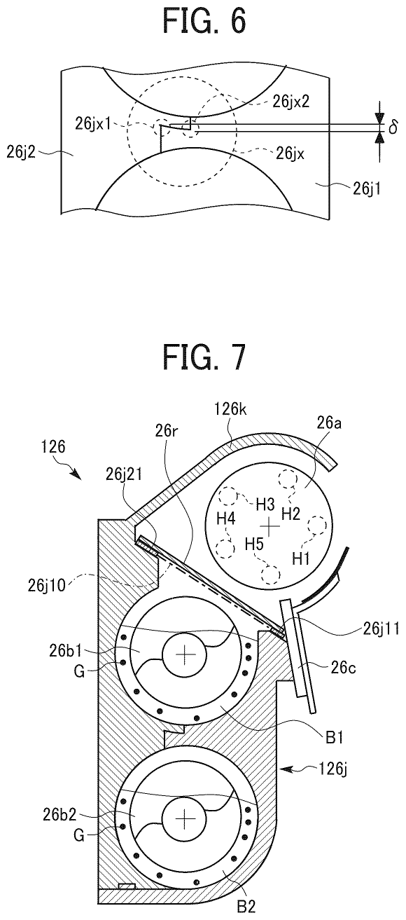

With reference to FIG. 6, in the present embodiment, a joint 26jx between the first lower developing case 26j1 and the second lower developing case 26j2 is formed in a nested manner. Accordingly, compared with a case where a joint is formed by joining a flat surface and another flat surface, a disadvantage that the developer G leaks from the joint 26jx between the first lower developing case 26j1 and the second lower developing case 26j2 can be reduced. In particular, in the present embodiment, the joint 26jx is formed such that an upper end 26jx1 of the lower fitting portion is located at a position higher than a lower end 26jx2 of the upper fitted portion by a specified height 8. With such a configuration, even if the developer G enters the joint 26jx, the entered developer G is likely to accumulate at the joint 26jx and be clogged, and thus a disadvantage that the developer G leaks from the joint 26jx is further reduced.

With reference to FIG. 4, the first lower developing case 26j1 and the second lower developing case 26j2 are formed such that a bottom portion of the first conveyance passage B1 including the first conveying screw 26b1 and a bottom portion of the second conveyance passage B2 including the second conveying screw 26b2 are arc-shaped (substantially concentric arcs with respect to the screw diameters) when viewed in a cross section orthogonal to the rotation axis direction of the first conveying screw 26b1 (or the second conveying screw 26b2). With such a configuration, dead spaces where the developer G tends to stagnate are less likely to be generated in the first conveyance passage B1 and the second conveyance passage B2 through which the developer G is conveyed. Modification

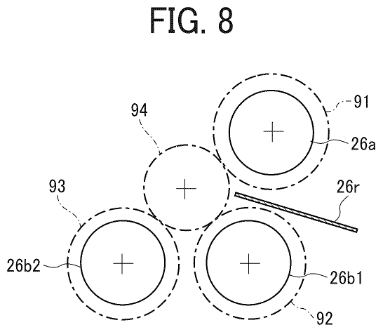

As illustrated in FIG. 8, the developing device 26 according to a modification includes a first gear 91, a second gear 92, a third gear 93, and an idler gear 94 on one end (drive side) in the longitudinal direction of the developing device 26. The first gear 91 is disposed on the rotation shaft 26a2x (see FIG. 3) of the developing roller 26a. The second gear 92 is disposed on the rotation shaft 26b11 (see FIG. 3) of the first conveying screw 26b1 (developer supply rotator). The third gear 93 is disposed on the rotation shaft 26b21 (see FIG. 3) of the second conveying screw 26b2. The idler gear 94 meshes with the first gear 91, the second gear 92, and the third gear 93. A driving force is transmitted from a drive motor to any one of the first gear 91, the second gear 92, the third gear 93, and the idler gear 94. Thus, each of the developing roller 26a, the first conveying screw 26b1, and the second conveying screw 26b2 is rotated in a specified direction. As illustrated in FIG. 8, in the developing device 26 according to the modification, when viewed in a cross section orthogonal to the rotation axis direction (the direction along the rotation shafts 26a2x and 26b11), a part of the sheet-shaped member 26r is disposed in a space surrounded by the first gear 91, the second gear 92, and the idler gear 94. With such a configuration, even when the sheet-shaped member 26r is pulled out from one end (drive side) of the developing device 26 in the longitudinal direction, a disadvantage that the sheet-shaped member 26r interferes with the first gear 91, the second gear 92, or the idler gear 94 is less likely to occur. In particular, in the modification, an outer diameter of the idler gear 94 (an outer diameter of tooth tip circle) is smaller than an outer diameter of the first gear 91, and smaller than an outer diameter of the second gear 92. Thus, the width of the sheet-shaped member 26r in the lateral direction can be relatively wide in the space surrounded by the first gear 91, the second gear 92, and the idler gear 94. The opening width of the opening 26j20 in the lateral direction in the base portion 26j10 can be easily wide.

As described above, the developing device 26 according to the present embodiment is removably installed to the body of the image forming apparatus 1 and contains the developer G. The developing device 26 includes the developing roller 26a and the first conveying screw 26b1. The developing roller 26a develops a latent image formed on the surface of the photoconductor drum 21 (image bearer). The first conveying screw 26b1 (developer supply rotator) that faces the developing roller 26a rotates in a specified direction to supply the developer G to the developing roller 26a. The sheet-shaped member 26r is removably installed and is disposed to separate the developing roller 26a and the first conveying screw 26b1 in the developing device 26 to form the developer pre-storage portion (substantially closed space) that stores the developer G near the first conveying screw 26b1 in the developing device 26. The upper developing case 26k that covers the developing roller 26a is disposed above the sheet-shaped member 26r. The lower developing case 26j that forms the developing case together with the upper developing case 26k is disposed below the sheet-shaped member 26r. The lower developing case 26j is divided into two parts, that is, the first lower developing case 26j1 and the second lower developing case 26j2, when viewed in a cross section orthogonal to the rotation axis direction of the developing roller 26a, and a sheet-shaped member 26r is directly or indirectly removably installed to straddle the first lower developing case 26j1 and the second lower developing case 26j2. With such a configuration, the sheet-shaped member 26r can be easily installed to separate the developing roller 26a and the first conveying screw 26b1 (developer supply rotator) from each other.

In the present embodiment, the process cartridge 20 does not include the developing device 26. The developing device 26 is a unit that is independently attachable to and detachable from the body of the image forming apparatus 1. On the other hand, the developing device 26 may be one of the components of the process cartridge 20. In this case, the process cartridge 20 including the developing device 26 is attachable to and detachable from the body of the image forming apparatus 1 as a unit. In such a configuration, similar effects to those of the present embodiment are also attained. The term “process cartridge” used in the present disclosure is defined as a unit that unites an image bearer and at least one of a charging device to charge the image bearer, a developing device to develop a latent image on the image bearer, and a cleaning device to clean the image bearer, and that is attachable to and detachable from the body of the image forming apparatus.

In the present embodiment, the developing device 26 includes the two conveying screws (i.e., the first conveying screw 26b1 and the second conveying screw 26b2) as the conveyors horizontally arranged in parallel and the doctor blade 26c disposed below the developing roller 26a. The configuration of the developing device 26 is not limited to the above-described configuration. In a developing device according to one or more embodiments of the present disclosure, three or more conveyors may be horizontally arranged in parallel, multiple conveyors may be arranged in parallel in the vertical direction, or a doctor blade may be disposed above a developing roller. In the present embodiment, the developing device 26 includes the conveying screw (the first conveying screw 26b1) in which the screw portion 26b12 is wound around the rotation shaft 26b11 as a developer supply rotator. However, the developer supply rotator is not limited thereto, and the developing device 26 may include a conveying paddle having a plurality of blade portions formed radially in the circumferential direction on a rotation shaft, for example, as a developer supply rotator. Such a case can also provide similar effects to those of the present embodiment.

Note that embodiments of the present disclosure are not limited to the above-described embodiments and it is apparent that the above-described embodiments can be appropriately modified within the scope of the technical idea of the present disclosure in addition to what is suggested in the above-described embodiments. Further, features of components of the embodiments, such as the number, the position, and the shape are not limited the embodiments and thus may be preferably set.

Aspects of the present disclosure may be, for example, combinations of first to tenth aspects as follows.

### First Aspect

A developing device (e.g., the developing device 26) detachably attachable to a body of an image forming apparatus (e.g., the image forming apparatus 1) and storing developer includes a developing roller (e.g., the developing roller 26a), a developer supply rotator, a sheet-shaped member (e.g., the sheet-shaped member 26r), an upper developing case (e.g., the upper developing case 26k), and a lower developing case (e.g., the lower developing case 26j). The developing roller develops a latent image formed on a surface of an image bearer (e.g., the photoconductor drum 21). The developer supply rotator is opposite the developing roller to rotate in a specified direction to supply the developer to the developing roller. The sheet-shaped member is removable and separates the developing roller and the developer supply rotator to form a developer pre-storage portion storing the developer in an inner space in which the developer supply rotator is disposed in the developing device. The upper developing case is disposed above the sheet-shaped member and covers the developing roller. The lower developing case is disposed below the sheet-shaped member and forms a developing case together with the upper developing case. The lower developing case is divided into two parts of a first lower developing case (e.g., the first lower developing case 26j1) and a second lower developing case (e.g., the second lower developing case 26j2) when viewed in a cross section orthogonal to a rotation axis direction of the developing roller. The sheet-shaped member is directly or indirectly removably installed to straddle the first lower developing case and the second lower developing case.

### Second Aspect

In the developing device (e.g., the developing device 26) according to the first aspect, the lower developing case (e.g., the lower developing case 26j) is divided into the first lower developing case (e.g., the first lower developing case 26j1) disposed on a side corresponding to a downstream side in a rotation direction of the developing roller (e.g., the developing roller 26a) and the second lower developing case (e.g., the second lower developing case 26j2) disposed on a side corresponding to an upstream side in the rotation direction of the developing roller at a substantially central position of the lower developing case when viewed in the cross section orthogonal to the rotation axis direction of the developing roller.

### Third Aspect

In the developing device (e.g., the developing device 26) according to the first or second aspect, a joint (e.g., the joint 26jx) between the first lower developing case (e.g., the first lower developing case 26j1) and the second lower developing case (e.g., the second lower developing case 26j2) is formed in a nested shape.

### Fourth Aspect

In the developing device (e.g., the developing device 26) according to the third aspect, the joint (e.g., the joint 26jx) is formed such that an upper end (e.g., the upper end 26jx1) of a lower fitting portion is positioned higher than a lower end (e.g., the lower end 26jx2) of an upper fitted portion.

### Fifth Aspect

In the developing device (e.g., the developing device 26) according to any one of the first to fourth aspects, the developer supply rotator is a first conveying screw (e.g., the first conveying screw 26b1). The first conveying screw includes a rotation shaft (e.g., the rotation shaft 26b11) and a screw portion (e.g., the screw portion 26b12) wound around the rotation shaft (e.g., the rotation shaft 26b11) to convey the developer in a rotation axis direction of the developer supply rotator. The developing device further includes a second conveying screw (e.g., the second conveying screw 26b2) opposite the first conveying screw via a wall (e.g., the partition 26e) to form a circulation passage of the developer together with the first conveying screw. The first lower developing case (e.g., the first lower developing case 26j1) and the second lower developing case (e.g., the second lower developing case 26j2) are formed such that each of a bottom portion of a first conveyance passage (e.g., the first conveyance passage B1) including the first conveying screw and a bottom portion of a second conveyance passage (e.g., the second conveyance passage B2) including the second conveying screw has an arc shape when viewed in a cross section orthogonal to a rotation axis direction of the first conveying screw or the second conveying screw.

### Sixth Aspect

In the developing device (e.g., the developing device 26) according to any one of the first to fifth aspects, the sheet-shaped member (e.g., the sheet-shaped member 26r) is removably installed via a base portion (e.g., the base portion 26j10) to straddle the first lower developing case (e.g., the first lower developing case 26j1) and the second lower developing case (e.g., the second lower developing case 26j2).

### Seventh Aspect

The developing device (e.g., the developing device 26) according to any one of the first to sixth aspects further includes a first gear (e.g., the first gear 91), a second gear (e.g., the second gear 92), and an idler gear (e.g., the idler gear 94). The first gear is disposed on a rotation shaft (e.g., the rotation shaft 26a2x) of the developing roller (e.g., the developing roller 26a). The second gear is disposed on a rotation shaft (e.g., the rotation shaft 26b11) of the developer supply rotator. The idler gear meshes with the first gear and the second gear. A part of the sheet-shaped member (e.g., the sheet-shaped member 26r) is disposed in a space surrounded by the first gear, the second gear, and the idler gear when viewed in a cross section orthogonal to the rotation shaft of the developing roller or the rotation shaft of the developer supply rotator.

### Eighth Aspect

In the developing device (e.g., the developing device 26) according to the seventh aspect, an outer diameter of the idler gear (e.g., the idler gear 94) is smaller than an outer diameter of the first gear (e.g., the first gear 91) and smaller than an outer diameter of the second gear (e.g., the second gear 92).

### Ninth Aspect

A process cartridge (e.g., the process cartridge 20) detachably attachable to the body of the image forming apparatus (e.g., the image forming apparatus 1) includes the developing device (e.g., the developing device 26) according to any one of the first to eighth aspects and the image bearer (e.g., the photoconductor drum 21) united with the developing device.

### Tenth Aspect

An image forming apparatus (e.g., the image forming apparatus 1) includes the developing device (e.g., the developing device 26) according to any one of the first to eighth aspects.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A developing device detachably attachable to a body of an image forming apparatus and storing developer, the developing device comprising:
a developing roller to develop a latent image formed on a surface of an image bearer;
a developer supply rotator opposite the developing roller to rotate in a specified direction to supply the developer to the developing roller;
a removable sheet-shaped member that separates the developing roller and the developer supply rotator to form a developer pre-storage portion storing the developer in an inner space in which the developer supply rotator is disposed in the developing device;
an upper developing case above the sheet-shaped member to cover the developing roller; and
a lower developing case below the sheet-shaped member to form a developing case together with the upper developing case, the lower developing case divided into a first lower developing case and a second lower developing case when viewed in a cross section orthogonal to a rotation axis direction of the developing roller,
wherein the sheet-shaped member is removably attached directly or indirectly to the first lower developing case and the second lower developing case to straddle the first lower developing case and the second lower developing case.

2. The developing device according to claim 1,
wherein the lower developing case is divided into the first lower developing case on a side corresponding to a downstream side in a rotation direction of the developing roller and the second lower developing case on a side corresponding to an upstream side in the rotation direction of the developing roller at a substantially central position of the lower developing case when viewed in the cross section orthogonal to the rotation axis direction of the developing roller.

3. The developing device according to claim 1,
wherein a joint between the first lower developing case and the second lower developing case is formed in a nested shape.

4. The developing device according to claim 3,
wherein the joint is formed such that an upper end of a lower fitting portion is positioned higher than a lower end of an upper fitted portion.

5. The developing device according to claim 1,
wherein the developer supply rotator is a first conveying screw including a rotation shaft and a screw portion wound around the rotation shaft to convey the developer in a rotation axis direction of the developer supply rotator,
wherein the developing device further comprises a second conveying screw that is opposite the first conveying screw via a wall and forms a circulation passage of the developer together with the first conveying screw, and
wherein the first lower developing case and the second lower developing case are formed such that each of a bottom of a first conveyance passage including the first conveying screw and a bottom of a second conveyance passage including the second conveying screw has an arc shape when viewed in a cross section orthogonal to a rotation axis direction of the first conveying screw or the second conveying screw.

6. The developing device according to claim 1,
wherein the sheet-shaped member is removably attached via a base portion to the first lower developing case and the second lower developing case to straddle the first lower developing case and the second lower developing case.

7. The developing device according to claim 1, further comprising:
a first gear on a rotation shaft of the developing roller;
a second gear on a rotation shaft of the developer supply rotator; and
an idler gear meshing with the first gear and the second gear,
wherein a part of the sheet-shaped member is in a space surrounded by the first gear, the second gear, and the idler gear when viewed in a cross section orthogonal to the rotation shaft of the developing roller or the rotation shaft of the developer supply rotator.

8. The developing device according to claim 7,
wherein an outer diameter of the idler gear is smaller than an outer diameter of the first gear and smaller than an outer diameter of the second gear.

9. A process cartridge detachably attachable to the body of the image forming apparatus, the process cartridge comprising:
the developing device according to claim 1; and
the image bearer united with the developing device.

10. An image forming apparatus comprising the developing device according to claim 1.
